(19) United States
(12) Patent Application Publication
(10) Pub. No.: US 2020/0095462 A1
(43) Pub. Date: Mar. 26, 2020

(54) BIOFOULING-RESISTANT COMPOSITIONS AND COATINGS, KITS FOR MAKING BIOFOULING-RESISTANT COMPOSITIONS, AND METHODS OF MAKING BIOFOULING-RESISTANT COATINGS

(71) Applicants: Henry Lobe, Annapolis, MD (US); John Knapp, Seattle, WA (US)

(72) Inventors: Henry Lobe, Annapolis, MD (US); John Knapp, Seattle, WA (US)

(21) Appl. No.: 16/138,169

(22) Filed: Sep. 21, 2018

(51) Int. Cl. C09D 183/04; C09D 5/16; C09D 7/63; C08K 5/00

(52) U.S. Cl. CPC C09D 183/04; C09D 5/1693; C09D 7/63; C08K 5/5419; C08K 5/0058; C08L 2312/00; C08K 5/0025

(57) ABSTRACT

Biofouling-resistant compositions, biofouling-resistant coatings, kits for making biofouling-resistant coatings, and methods of making biofouling-resistant coatings are described.

### BACKGROUND

A large number of organisms such as barnacles, bacterial slimes, ascidians, serupulas, fresh- and salt-water mussels, polyzoan, green algae, sea lettuce, and the like live in the waters of the sea, rivers, lakes, and swamps. These plants and animals cause various types of damages, and particularly adhere to and degrade the performance of marine instruments, vessels, and sensors.

The biofouling of marine and other aquatic instrumentation, in particular, is a long-felt and well-established problem by those in industry, science and resource management. Biofouling inhibits the performance of marine instrumentation, thereby adversely affecting the data acquired as well as adding to the cost of maintaining the instruments. Problems due to biofouling of marine instrumentation have occurred for many decades and continue to be a major factor inhibiting the effective use of submerged instruments.

Biofouling on a marine instrument housing causes messy handling of the instrument upon retrieval; increases the surface area of the housing thereby making the instrument more susceptible to forces imparted on it from current, waves or other moving water; increases the weight of the instrument both in and out of the water; increases personnel time to clean with an associated increase in operation and maintenance cost.

Additionally, the biofouling on the sensor elements can attenuate sensor signals, disrupt critical spacing between conductor elements, disable optical devices due to blockage of light transmission through their elements, block open ports of pressure or sensing chambers, clogs open flow cylinders of some sensors, and some biofouling organisms, such as barnacles, can bore into the transducer elements, thereby damaging them.

Prior attempts to address the problems associated with biofouling of sensor elements have involved using mechanical wipers to remove biological material from the sensor elements, various grease types that work through ablative processes or through the incorporation of active agents such as pepper extracts or other traditional metal biocides, tributyl tin tablets that sterilize the local sensing area or chamber contained sensor area, using traditional paints containing active biocides, sensor encapsulation boxes that prevent light from contacting the sensor element when it is not in use and thereby prevent or limit biofouling, chlorine systems that often use electrolysis to generate chlorines from seawater, various chemical treatments that are injected into a closed chamber system and using copper mounting plates for sensor components.

Prior art techniques have obvious limitations. For instance, while use of grease for preventing biofouling of instrument housing may be initially effective; its effectiveness diminishes over time as the grease is washed off. Furthermore, greases may have adverse environmental effects as many types of grease used to prevent fouling are toxic to non-biofouling marine life and to workers handling and maintaining the grease.

Additionally, metal biocide released from various paints or greases cannot work with electrode or electromagnetic sensor elements as they will disrupt signals generated by the sensor elements. Furthermore, paints containing active biocides or other biocide applications lose their efficacy over time.

Mechanical wipers have been shown to improve the duration that optical instruments can be deployed. Fouling does, however, occur and the mechanical systems use a significant amount of battery power for battery-powered devices.

The use of tapes on instrument housing does not reduce the degree of biofouling; rather, tapes simply protect the instrument housing and allow the user to clean the instrument by removing the tape rather than scraping the instrument.

Paints or other opaque coatings will not work, for example, on optical sensors as they will disrupt light transmission in the same manner that biofouling itself does. Further, where marine instruments have been coated with opaque biofouling-resistant material, the coating occludes the identity of the instrument causing manufacturers to lose their identifying look and branding, serial numbers, and other identification markings.

Currently available marine coatings do not include optically clear silicones nor do they address the issue of poor silicone adhesion to a wide variety of marine instrument surfaces, particularly adhesion promotion in a manner that does not interfere with light transmission. Hence, there is need for biofouling-resistant coating compositions specially formulated for high levels of light transmission without impeding the effectiveness of the submerged instruments.

Additionally, it is conventionally understood that lower modulus (i.e. softer) coatings accumulate less fouling and facilitate the removal of any accumulated fouling. It is generally understood that the lower the modulus of a material, the less durable the material is. Thus, according to conventional understanding, there is a tradeoff between fouling release properties and durability. Although mechanical performance generally improves with higher modulus (i.e. harder) coatings, it is conventionally understood that fouling release properties are obtained with lower modulus coatings. Accordingly, there is a present need for a biofouling-resistant coating that has both durability and good fouling release properties.

The present disclosure seeks to fulfill these needs and provides further related advantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an aspect the present disclosure provides biofouling-resistant coating on a substrate used for submerged marine applications, the coating generally including a tie coat coupled to the substrate; and a biofouling-resistant composition coupled to the tie coat, the biofouling-resistant composition comprising a reaction product of a mixture comprising: a curably reactive organopolysiloxane comprising: at least one terminal reactive functional group; and at least one silicon-bonded organic group; and an organosilane cross linking agent; wherein the biofouling-resistant coating has a Shore A durometer of greater than 20, and wherein the biofouling-resistant coating has greater than or equal to 25% light transmission of wavelengths between 400 nm and 800 nm.

In another aspect, the present disclosure provides a kit generally including a curably reactive organopolysiloxane comprising at least one terminal reactive functional group; and at least one silicon-bonded organic group; and an organosilane cross linking agent, wherein a reaction product of a mixture comprising the curably reactive organopolysiloxane and the organosilane cross linking agent comprises an optically clear, biofouling-resistant composition having greater than or equal to 25% light transmission of wavelengths between 400 nm and 800 nm, a refractive index of 1.30 to 1.56, and a Shore A durometer of greater than 20.

In yet another aspect, the present disclosure provides a method of forming biofouling-resistant coating on a substrate used for submerged marine applications generally including coupling a tie coat to the substrate; applying to the tie coat a mixture comprising: a curably reactive organopolysiloxane including: at least one terminal reactive functional group; and at least one silicon bonded organic group; and an organosilane cross linking agent; and curing the mixture comprising the curably reactive organosiloxane and the organosilane cross linking agent, wherein the biofouling-resistant coating has a Shore A durometer of greater than 20, and wherein the biofouling-resistant coating has greater than or equal to 25% light transmission of wavelengths between 400 nm and 800 nm.

### DETAILED DESCRIPTION

Described herein are biofouling-resistant compositions, biofouling-resistant coatings made therefrom, kits for making biofouling-resistant compositions, and related methods of making biofouling-resistant coatings.

The detailed description set forth below is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of one or more embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

Biofouling-Resistant Coatings

In an aspect, the present disclosure provides a biofouling-resistant coating on a substrate. In an embodiment, the biofouling-resistant coating comprises a reaction product of a curably reactive organopolysiloxane having reactive functional groups and silicon bonded organic groups; and a cross linking agent.

Curably Reactive Organopolysiloxane

In an embodiment, the curably reactive organopolysiloxane is a reactive polydimethylsiloxane (PDMS) having the formula:

(H₃C)₃SiO[Si(CH₃)₂O]ₙSi(CH₃)₃ I

where n is a number between about 3 and 10,000.

As discussed further herein with respect to the methods of the present disclosure, in an embodiment, the curably reactive polydimethylsiloxane is configured to be cured by a reaction selected from the group selected from an addition reaction, a condensation reaction, a hydrolyzation reaction, a dealcoholyzation reaction, a deacetification reaction, a dehydroxyamination reaction, and combinations thereof.

In an embodiment, the curably reactive organopolysiloxane is configured to react with an acetoxysilane cross linking agent to cure the curably reactive organopolysiloxane. In certain embodiments, such curably reactive organopolysiloxanes include reactive groups selected from the group consisting of hydrogen, hydroxyl groups, alkoxy groups, alkoxy, and combinations thereof. Accordingly, in an embodiment, the curably reactive organopolysiloxanes include siloxane units of the general structure:

RₓR¹SiO₍₃₋ₓ₎ II

wherein

x is 1 or 2,

each R is a monovalent hydrocarbon group having up to 20 carbon atoms, and

R¹ is selected from the group consisting of a hydrogen, a hydroxyl (OH) group, and an alkoxy group (OR), such as methoxy, ethoxy, propenyloxy, and the like. In an embodiment, R is methyl and R¹ is hydroxyl.

In an embodiment, each R is independently selected from the group consisting of a methyl group, an ethyl group, a propyl group, and a butyl group. In an embodiment, R is a phenyl group.

In an embodiment, the curably reactive organopolysiloxane is according to the formula:

R_{y}R¹SiO_{(4-y)} III

wherein

y is a number between 0 and 3;

R is a monovalent hydrocarbon group having up to 20 carbon atoms, and

R¹ is selected from the group consisting of a hydrogen, a hydroxyl (OH) group, and an alkoxy group (OR), such as methoxy, ethoxy, and propenyloxy.

In certain embodiments, the curably reactive organopolysiloxane includes one or more groups selected from the group consisting of acrylates, carbonates, and polybutylenes.

In an embodiment, the curably reactive organopolysiloxane is a mixture or a copolymer of the curably reactive organopolysiloxanes described herein.

In an embodiment, the curably reactive organopolysiloxane is an organopolysiloxane having the formula:

OH(Si(CH₃)₂))_{z}H IV

wherein z is an integer of 3 to 10,000.

In an embodiment, the curably reactive organopolysiloxane has a viscosity between about 10,000 cP and 400,000 cP at 25° C.

Terminal Reactive Functional Groups

In an embodiment, the curably reactive organopolysilaxnes described herein include a terminal reactive group at at least one terminal end of the curably reactive organopolysiloxane.

In an embodiment, the terminal reactive group is selected from the group consisting of a hydroxyl group, an alkoxy group, an aryloxy group, an amino group, an amido group, a halogen, and a vinyl group. In an embodiment, the curably reactive organopolysiloxane includes two or more terminal reactive groups wherein the two or more terminal reactive groups are different. In an embodiment, the organopolysiloxane includes two or more terminal reactive groups wherein the two or more terminal reactive groups are the same. In an embodiment, the curably reactive organopolysiloxane is chosen from the group consisting of a polydimethylsiloxane capped at two or more molecular terminals with dimethylvinylsiloxy groups, a methylvinylsiloxane.dimethylsiloxane copolymer capped at two or more molecular terminals with trimethylsiloxy groups, a methylvinylsiloxane.dimethylsiloxane copolymer capped at two or more molecular terminals with dimethylvinylsiloxy groups, a methylvinylsiloxane.dimethylsiloxane copolymer capped at two or more molecular terminals with dimethylvinylsiloxy groups, a methyl(3,3,3-trifluoropropyl)siloxane.dimethylsiloxane copolymer capped at two or more molecular terminals with dimethylvinylsiloxy groups, a polydimethylsiloxane capped at two or more molecular terminals with dimethylhexenylsiloxy groups, a methylhexenylsiloxane.dimethylsiloxane copolymer capped at two molecular terminals with trimethylsiloxy groups, a methylhexenylsiloxane.dimethylsiloxane copolymer capped at two or more molecular terminals with dimethylhexenylsiloxy groups, a methylphenylsiloxane.dimethylsiloxane copolymer capped at two or more molecular terminals with dimethylhexenylsiloxy groups, and a methyl(3,3,3-trifluoropropyl)siloxane.dimethylsiloxane copolymer capped at two or more molecular terminals with dimethylhexenylsiloxy groups.

In an embodiment, the curably reactive organopolysiloxane is a vinyl-terminated polydimethylsiloxane. In an embodiment, the vinyl-terminated polydimethylsiloxane is a reaction product of a hydroxyl-terminated polydimethylsiloxane with dimethylvinylchlorosilane having the following chemical formula:

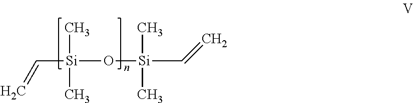

The vinyl groups in the above polydimethylsiloxane polymer are configured copolymerize with vinyltrialkyloxysilane, and also take part in a cross-linking reaction with 1,3-divinyltetramethyldisiloxane.

Silicon-Bonded Organic Group

In an embodiment, the curably reactive organopolysiloxanes described herein include one or more silicon-bonded organic groups. In an embodiment, the one or more silicon-bonded organic groups are independently selected from the group consisting of a methyl group, an ethyl group, a vinyl group, a haloalkyl group, and a phenyl group.

Organosilane Cross Linking Agent

The biofouling-resistant coatings described herein include a reaction product between curably reactive organopolysiloxane and an organosilane crosslinking agent.

In an embodiment, the organosilane crosslinking agent is an acetoxysilane cross linking agent. In an embodiment, the organosilane cross linking agent has the formula:

R²₄₋ₐSiR³ₐ VI

wherein,

a is a number between 2-4;

each R² is a monovalent hydrocarbon group having up to 20 carbon atoms selected from the group consisting of an alkyl group and a phenyl group, and

R³ is an acetoxy group.

In an embodiment, each R² is a group independently selected from the group consisting of a methyl group, an ethyl group, a propyl group, a butyl group.

In an embodiment, the acetoxysilane are selected from the group selected from methyltriacetoxysilane and ethyltriacetoxysilane. In an embodiment, the acetoxy cross linking agent is present in the biofouling-resistant compositions described herein in an amount of between about 10 ppm to about 100 ppm. In an embodiment, the acetoxy cross linking agent is present in the biofouling-resistant compositions described herein in an amount of between about 1 wt % to about 10 wt % based on the weight of the curably reactive organopolysiloxane.

In an embodiment, the amount of organosilane cross linking agent is sufficient to provide a ratio of reactive groups on the organopolysiloxane to acetoxy groups of about 0.1 to about 10. In an embodiment, the amount of organosilane cross linking agent is sufficient to provide a ratio of reactive groups on the organopolysiloxane to acetoxy groups of about 0.5 to about 2.0.

In an embodiment, the organosilane cross linking agent is a polyorganosiloxane that includes at least two silicon-bonded hydrogen atoms and one or more groups selected from the group consisting of alkyl groups, phenyl groups, aryl groups, phenethyl groups, aralkyl groups, and haloalkyl groups. In an embodiment, the organosilane cross linking agent is a polyorganosiloxane that includes at least two silicon-bonded hydrogen atoms and one or more groups selected from the group consisting of methyl groups, ethyl groups, propyl groups, phenyl groups, tolyl groups, phenethyl groups, 3-chloropropyl groups, and 3,3,3-trifluoropropyl groups.

In an embodiment, the organosilane cross linking agent is selected from group consisting of a polymethylhydrogensiloxane capped at molecular terminals with trimethylsiloxy groups; a methylhydrogensiloxane-dimethylsiloxane copolymer capped at molecular terminals with trimethylsiloxy groups; a cyclic methylhydrogensiloxane-dimethylsiloxane copolymer capped at molecular terminals with dimethylhydrogensiloxy groups; a methylhydrogensiloxane-dimethylsiloxane copolymer; cyclic polymethylhydrogensiloxane; an organosiloxane copolymer including siloxane units R₃SiO_{1/2}, siloxane units R₂HSiO_{1/2}, and siloxane units SiO₄/2; an organosiloxane copolymer including siloxane units R₂HSiO_{1/2} and siloxane units SiO_{4/2}; an organosiloxane copolymer including siloxane units of formula RHSiO_{2/2} and siloxane units of formula RSiO_{3/2} or siloxane units of formula HSiO_{3/2}, and a mixture thereof, wherein R is a univalent saturated hydrocarbon group or a halogenated alkyl group.

Durometer

As discussed further herein, it is conventionally understood that lower modulus (i.e. softer) coatings accumulate less biofouling. Further, softer coatings are generally less durable. Thus, according to conventional understanding, there is a tradeoff between fouling release properties and durability.

It has been surprisingly found that the biofouling-resistant coatings described herein have both a high resistance to biofouling and a higher durometer relative to conventional biofouling-resistant coatings. In this regard, the biofouling-resistant coatings described herein are both resistant to biofouling and are more durable than conventional biofouling-resistant coatings.

In an embodiment, the biofouling-resistant coatings of the present disclosure have a Shore A hardness of greater than 20. In an embodiment, the biofouling-resistant coatings of the present disclosure have a Shore A hardness of between about 20 and about 70. In an embodiment, the biofouling-resistant coatings of the present disclosure have a Shore A hardness of between about 25 and about 60. In an embodiment, the biofouling-resistant coatings of the present disclosure have a Shore A hardness of between about 27 and about 35.

Durometer of the biofouling-resistant coatings of the present disclosure can be determined in any suitable manner known in the art, such as by ASTM D2240.

Biofouling Resistance

The compositions and coatings described herein are biofouling-resistant. As used in this description, “biofouling resistant,” “fouling release,” and “antibiofouling” are used interchangeably to refer to compositions and coatings that resist or otherwise inhibit the accumulation of fouling organisms, such as such as barnacles, bacterial slimes, ascidians, serupulas, fresh- and salt-water mussels, polyzoan, green algae, sea lettuce and the like, and/or fouling chemicals, such as non-specific protein adhesion, on surfaces of such compositions and coatings. In an embodiment of the present disclosure, hard fouling is removed with a sheer force of less than about 0.4 MPa from surfaces coated with the biofouling-resistant compositions described herein. In an embodiment of the present disclosure, hard fouling is removed with a sheer force of between about 0.01 MPa and about 0.070 MPa.

As described further herein, in certain embodiments, the biofouling-resistant coatings and compositions of the present disclosure have both a high resistance to biofouling, such as hard fouling being removed with a sheer force of between about 0.01 MPa and about 0.070 MPa, and a relatively high durometer, such as a Shore A hardness between about 20 and about 70. In this regard, the biofouling-resistant coatings and compositions are both resistant to the accumulation of biofouling and are more durable than conventional coatings.

Optical Transparency

Additionally, in certain embodiments, the biofouling-resistant coatings described herein have high transmission of light. In this regard and as described further herein, the biofouling-resistant coatings described herein are suitable for use in coating surfaces, for example, of analytical devices that require transmission of light.

In an embodiment, the biofouling-resistant compositions described herein have greater than or equal to 25% light transmission of wavelengths between 400 nm and 800 nm. In an embodiment, the biofouling-resistant compositions described herein have greater than or equal to 50% light transmission of wavelengths between 400 nm and 800 nm. In an embodiment, the biofouling-resistant compositions described herein have greater than or equal to 70% light transmission between 400 nm and 800 nm. In an embodiment, the biofouling-resistant compositions described herein have greater than or equal to 90% light transmission between 400 nm and 800 nm. In an embodiment, the biofouling-resistant compositions described herein have greater than or equal to 95% light transmission between 400 nm and 800 nm.

Transmission spectra may be determined in any suitable manner known in the art, such as by the use of a UV-Visible spectrometer using a 600 groove/mm grating with a 300 nm blaze wavelength and 25 μm slit. 100% transmission is effectively passing all of the tested wavelengths of light through the sample.

In an embodiment, the biofouling-resistant compositions described herein have a refractive index of 1.30 to 1.56 at 25° C. In an embodiment, the biofouling-resistant compositions described herein have an index of refraction above 1.40 at 25° C. In an embodiment, the biofouling-resistant compositions described herein have an index of refraction between about 1.45 to about 1.56 at 25° C.

Fillers

In an embodiment, the biofouling-resistant compositions described herein include one or more fillers. In an embodiment, the fillers include rheological control and reinforcing fillers. In an embodiment, the fillers used in the biofouling-resistant compositions control viscosity, thixotropy, flow, sag resistance, and sedimentation.

In an embodiment, one or more fillers are added the curably reactive organopolysiloxane, thereby adjusting the viscosity of the biofouling-resistant composition such that a uniform coating results with a thickness of between 50 μm and 400 μm. As discussed further herein, in an embodiment, the thickness of the biofouling-resistant coating varies between less than or equal to ±100 μm when measured over a square centimeter.

In an embodiment, the filler includes a silica-based filler, such as precipitated silica or fumed silica. In an embodiment, surfaces of the silica-based fillers are coated with a coating or treated, for example, by pre-treatment or treatment in situ, to render them hydrophobic. In an embodiment, the fillers have surfaces comprising siloxane and silanol functionalities. In an embodiment, the coating or surface treatment is selected from the group consisting of silanes (e.g. trimethylchlorosilane), silazanes (e.g. hexamethyldisilazane), and low molecular weight organopolysiloxanes (e.g. as organoalkoxysilane, organochlorosilane, organosilazane, or other organic silicon compound), and mixtures thereof. In an embodiment, the biofouling-resistant compositions including dimethylyvinyl-terminated dimethylsiloxane, dimethylyvinylated further include trimethylated silica. In an embodiment, biofouling-resistant compositions including hydroxyl-terminated dimethylsiloxane further include untreated amorphous fumed silica.

In an embodiment, the filler includes hydrophobic fumed silica. In an embodiment, such hydrophobic fumed silica is a reaction product of surface treating hydrophilic fumed silica with a composition, such as Aerosil®, to render it water repellent. For example, Degussa's Aerosil® P202 is treated with polymethylsiloxane (silicone oil) and Aerosil® R805 is treated with trimethoxyoctylsilane.

In an embodiment, the filler includes fumed silica (modified or unmodified) selected from the group consisting of Bindzil® 215 (anionic surface), Bindizil® 15/500 (anionic surface), Bindizil® 30/360 (anionic surface), Bindizil® 830 (anionic surface), Bindizil® 2034 DI (anionic, acid surface), Bindizil® 9950 (anionic surface), Bindizil® 50/80 (anionic surface), Bindizil® CAT80 (cationic surface), Bindizil® CC30 (silane treated surface), and Cabosil®.

In an embodiment, filler generally increases a durometer of a biofouling-resistant coating described herein. In an embodiment, the filler is present is an amount of between about 0.1 to about 70 parts per hundred of the curably reactive organopolysiloxane. In an embodiment, the filler is present is an amount ranging from about 5 wt % to about 70 wt % of the curably reactive organopolysiloxane. In an embodiment, the filler is present is an amount ranging from about 7 wt % to about 35 wt % of the curably reactive organopolysiloxane. In an embodiment, the filler is present is an amount ranging from about 7 wt % to about 15.0 wt % of the curably reactive organopolysiloxane. In an embodiment, the filler is present is an amount ranging from about 30 wt % to about 60 wt % of the curably reactive organopolysiloxane. The filler amount depends on, for example, resin chemistry, molecular weight distribution, dispersion condition (intensity, equipment), and nature of other additives used in formulating the biofouling-resistant composition.

In an embodiment, the biofouling-resistant compositions described herein include a filler comprising nanoparticles of amorphous fumed silica. In an embodiment, the amorphous fumed silica nanoparticles have an average smallest dimension between about 1 nm and about 400 nm. In an embodiment, the amorphous fumed silica nanoparticles have an average smallest dimension between about 2 nm to less than about 300 nm. In an embodiment, the amorphous fumed silica nanoparticles have an average smallest dimension between about 5 nm to less than about 150 nm. In an embodiment, the amorphous fumed silica nanoparticles have an average smallest dimension between about 1 nm to about 100 nm. In an embodiment, the amorphous fumed silica nanoparticles have an average smallest dimension between about 5 nm and about 50 nm. In an embodiment, the amorphous fumed silica nanoparticles have an average smallest dimension between about 1 nm and about 25 nm. In an embodiment, the amorphous fumed silica nanoparticles have an average smallest dimension between about 1 nm and about 10 nm.

In an embodiment, the nanoparticles of amorphous fumed silica have a surface area of between about 50 m²/g and about 800 m²/g. In an embodiment, the nanoparticles of amorphous fumed silica have a surface area of between about 120 m²/g and about 200 m²/g.

In order to increase, for example, the strength, viscosity, and stability of biofouling-resistant coatings, additives at a concentration of about 7-30% by weight of fumed silica may be added. In an embodiment, such additives include glycols and non-ionic surfactants. In an embodiment, glycols include ethylene glycol. In an embodiment, glycols include glycols having molecular weights up to about 750. The actual materials and the amounts used are a function of both formulation and customer specifications. The mechanism by which the additives function depends on the particular material used. Glycerin, glycol, and other polyhydroxyl compounds have multiple hydrogen bonding sites that allow them to act as “bridging agents” between fumed silica aggregates. This bridging strengthens the silica network, resulting in increased viscosity.

In an embodiment, the biofouling-resistant compositions include a resin filler in addition to fumed silica or in lieu of fumed silica. In an embodiment, such resin fillers increase material strength and rheological control of the biofouling-resistant compositions. In an embodiment, resin fillers include short chain silicone polymers, such as short chain polymethylsilsesquioxane soluble in the oganopolysiloxane.

Metal Catalysts

In an embodiment, the biofouling-resistant composition includes a metal catalyst suitable to catalyze a reaction between the curably reactive organopolysiloxane and the organosilane cross linking agent. In an embodiment, the metal catalyst is suitable for use in acetoxy curing curably reactive organopolysiloxane.

In an embodiment, the metal catalyst includes, for example, organic metal compounds such as organotin salts. In an embodiment, the metal catalyst is selected from the group consisting of stannous octoate, dibutyltin dilaurate, dibutyltin diacetate, dimethyltin dineodecanoate, dibutyltin dimethoxide, isobutyl tin triceroate, dimethyltin dibutyrate, dimethyltin dineodecanoate, triethyltin tartrate, tin oleate, tin naphthenate, tin butyrate, tin acetate, tin benzoate, tin sebacate, tin succinate, and platinum.

In an embodiment, the metal catalyst is present in an amount of between about 0.001 wt % and 10 wt % based on the weight of the remaining components of the biofouling-resistant composition.

In an embodiment, the biofouling-resistant compositions described herein include a curing catalyst in an amount sufficient for cross-linking and curing the curably reactive organopolysiloxane and the cross linking agent. In an embodiment, the catalytic amount is between about 0.1 ppm to about 1,000 ppm of the pure metal contained the catalyst per total amount of curably reactive organopolysiloxane.

In one embodiment, the curing catalyst comprises an organic peroxide such as 2,5-dimethyl-2,5-di(t-butylperoxy) hexane, 2,4-dichloro-benzoyl peroxide, or dicumyl peroxide for peroxide-initiated curing.

In an embodiment, the metal catalyst is a platinum-based catalyst or a platinum group metal catalyst. In an embodiment, the metal catalyst includes a platinum group metal selected from the group consisting of ruthenium, rhodium, palladium, osmium, iridium, platinum, and compounds thereof that possess a catalytic activity with regard to curing reaction between the curably reactive organopolysiloxane and the organosilane cross linking agent. In an embodiment, the metal catalyst is selected from the group consisting of platinum on a fine-powdered silica carrier, chloroplatinic acid, an alcohol solution of a chloroplatinic acid, a platinum-olefin complex, a divinyl-tetramethyldisiloxane complex of a chloroplatinic acid, a divinyl-tetramethyldisiloxane complex of platinum, and thermoplastic resin powders containing platinum-group metals.

Diluents

In an embodiment, the biofouling-resistant compositions described herein include an optically clear ingredients, such as diluents, extenders, silicone fluids, silicone resins, stabilizers, surfactants, biocides, and processing aids, such as cyclic or linear polydiorganosiloxanes.

Diluents are often suitable, for example, to decrease a viscosity of the curably reactive polyorganosiloxane sufficiently to permit easy application of the biofouling-resistant composition to a substrate.

In an embodiment, a biofouling resistant-composition according to aspects of the present disclosure comprising dimethylsiloxane, dimethylvinyl-terminated, further comprises up to 35 wt % vinyl-containing resin, such as polyalkylakenylsiloxane (Vi[(CH₃)₂SiO]n Si(CH₃)₂Vi).

Examples of diluents include silicon-containing materials, such as hexamethyldisiloxane, octamethyltrisiloxane, and other short chain linear siloxanes; cyclic siloxanes such as octamethylcyclotetrasiloxane and decamethylcyclopentasiloxane; organic materials such as alkanes and alkenes, including ethylbenzene, xylene, benzene, toluene, alcohol, mineral spirit, acetone, tetrahydrofuran, methylethylketone, methylisobutylketone, or any other material or mixture of materials which can dilute the formulation without affecting any of the components of the formulation.

In an embodiment, a biofouling-resistant composition according to aspects of the present disclosure comprises 40-70 wt % dimethyl, methylhydrogen siloxane; 15-40 wt % dimethly siloxane, dimethylvinyl-terminated; 10-30 wt % dimethylvinylated- and trimethylated-silica; 1.0-5.0 wt % tetramethyl-tetravinyl-cyclotetrasiloxane; less than 1 wt % ethylbenzene, 0.5 wt % xylene, and a catalytic amount of platinum.

In another embodiment, a biofouling-resistant composition according to aspects of the present disclosure comprises 60-90 wt % vinylpolydimenthylsiloxane; 10-30 wt % vinyl-containing resin (polyalkylalkenylsiloxane); 0.0001 wt % benzene; 0.0001 wt % toluene, and a catalytic amount of platinum.

In another embodiment, a biofouling-resistant composition according to aspects of the present disclosure comprises about 60-80 wt % dimethylsiloxane, hydroxy-terminated; 7.0-13.0 wt % amorphous fumed silica; 1.0-5.0 wt % ethyltriacetoxysilane; and 1.0-5.0 wt % methyltriacetoxysilane. Suitable additives for this embodiment include one or more alkoxysilanes selected from the group consisting of tetramethoxysilane, tetraethoxy silane, dimethyldimethoxysilane, methylphenyldimethoxysilane, methylphenyldiethoxysiolane, phenyltrimethoxysilane, methyltrimethoxy silane, methyltriethoxy silane, vinyltrimethoxysilane, allyltrimethoxy silane, and allyltriethoxysilane.

Tie Coat

In an embodiment, the biofouling-resistant coatings described herein include a tie coat configured to form an intimate bond with a substrate. In an embodiment, such a tie coat is applied to the substrate prior to applying the biofouling-resistant composition, as described further herein. In an embodiment, commercially available tie coats are used. In an embodiment, the tie coat includes, for example, primers, epoxy resins, and barrier coats or any pre-antifoulant coat layer.

In an embodiment, the tie coat is coupled to the substrate; and the biofouling-resistant composition coupled to the tie coat. As used coupling can include covalent bonding and/or non-covalent interactions between, for example, the tie coat and the substrate or the tie coat and the biofouling-resistant composition. Additionally, coupling can include direct coupling between two components, such as when the tie coat is in direct contact with the substrate, or indirect coupling, such as when the tie coat is coupled to the substrate through an adhesive layer.

U.S. Pat. Nos. 5,449,553, 5,593,732, and US Published Application No. 20080138634 disclose tie coat compositions and are incorporated herein by reference in their entireties. In an embodiment, the tie coat is selected from the group consisting of SS4179 (GE/MOMENTIVE), SS4044 (GE/MOMENTIVE), and SS4004 (GE/MOMENTIVE).

In an embodiment, a suitable tie coat has a viscosity of from about 400 centipoise to about 400,000 centipoise at about 25° C. In an embodiment, a suitable tie coat has a viscosity of from about 100,000 centipoise to about 300,000 centipoise at 25° C. In an embodiment, a suitable tie coat has a viscosity of from about 95,000 centipoise to about 150,000 centipoise at 25° C.

In one embodiment, the tie coat is coupled to the biofouling-resistant composition through a silicone cross linking between the tie coat and the biofouling-resistant composition. Such silicone cross linking is covalent and provides durability to the biofouling-resistant composition from the tie coat. Such a biofouling-resistant coating, including a tie coat, a biofouling-resistant composition, and a silicone cross link covalently coupling them together, has a high level of durability.

In an embodiment, a clear epoxy adhesive is first applied to the substrate optionally followed by the tie coat prior to applying the biofouling-resistant composition described herein. In an embodiment, the clear epoxy adhesive includes a polymer blend containing a silane coupling agent including primary or secondary amines. Such a clear epoxy adhesive adheres strongly to both similar and dissimilar materials including metals, glass, ceramics, vulcanized rubbers, and many plastics. One such clear epoxy resin is a polyamine/polyamide blend comprising 65-70 wt % bisphenol A-epichlorohydrin polymer; 30-35 wt %, alkyl (C12-C14) glycidyl ether; diluent n-butyl glycidyl ether; dimer C18-unsaturated fatty acids; and reaction products with polyethylenepolyamines (Polyamide Resin). Another clear epoxy resin in accordance with embodiments of the present disclosure comprises 25-50 wt % poly(oxypropylenediamine); 10-25 wt % reaction products of isophorone diamine with phenol/formaldehyde; 10-25 wt % isophoronediamine; 10-25 wt % reaction products of benzene-1,3-dimethaneamine with hydroxybenzene and formaldehyde; 5-12 wt % hydroxybenzene; and 5-12 wt % m-xylene diamine. Another clear epoxy resin in accordance with embodiments of the present disclosure comprises 50-70 wt % bisphenol-A type epoxy resin; 10-20 wt % benzyl alcohol, 10-20 wt % bisphenol-F type epoxy resin; 0.1-0.3 wt % ethylene glycol monobutyl ether. U.S. Pat. No. 6,391,464, entitled Epoxy Coatings and Surfaces Coated Therewith, disclose other epoxy coating compositions suitable for use in embodiments of the biofouling-resistant compositions and coatings of the present disclosure and is hereby incorporated by reference is its entirety.

In another embodiment, the tie coat comprises a polyurethane adhesive. In an embodiment, the polyurethane adhesive includes a polyurethane adhesive selected from the group consisting of a one-component polyurethane adhesive, a two-component polyurethane adhesive, and combinations thereof. In an embodiment, the polyurethane adhesive is a liquid at 23° C. In an embodiment, the polyurethane adhesive is not a liquid at 23° C., and is a hot-melt adhesive that is liquid at temperatures above 23° C. In an embodiment, the polyurethane adhesive includes a solvent. In an embodiment, the polyurethane adhesive does not include a solvent. In an embodiment, the polyurethane adhesive is crosslinked, such as through a reaction of one or more of NCO groups, OH groups, amino groups, and carboxyl groups. In an embodiment, the polyurethane adhesive is crosslinked through a reaction of the NCO groups of the polyurethane adhesive with moisture. In an embodiment, the polyurethane adhesive further includes a catalyst, for example amine or tin catalysts, to accelerate such reactions.

In an embodiment, the polyurethane adhesive is a polyisocyanate adhesive including two or more isocyanate groups. Suitable polyisocyanates include, for example, 1,5-naphthylene diisocyanate (NDI), 2,4-diphenylmethane diisocyanate (MDI), 4,4′-diphenylmethane MDI, hydrogenated MDI (H12MDI), xylylene diisocyanate (XDI), tetramethylxylylene diisocyanate (TMXDI), di-alkylene diphenylmethane diisocyanate, tetraalkylene diphenylmethane diisocyanate, 4,4′-dibenzyl diisocyanate, 1,3-phenylene diisocyanate, 1,4-phenylene diisocyanate, tolylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, methylene triphenyl triisocyanate (MIT), phthalic acid bis-isocyanatoethyl ester, trimethylhexamethylene diisocyanate, 1,4-diisocyanatobutane, 1,12-diisocyanatododecane, and dimer fatty acid diisocyanate.

Suitable at least trifunctional isocyanates include polyisocyanates that are reaction products trimerization or oligomerization of diisocyanates or reaction products of diisocyanates with low molecular weight polyfunctional compounds containing hydroxyl or amino groups. Commercially obtainable examples are trimerization products of the isocyanates HDI, MDI or IPDI or adducts of diisocyanates and low molecular weight triols, such as trimethylolpropane or glycerol.

In another embodiment, the polyurethane adhesive is a silane-functionalized polyurethane. Such silane-functionalized polyurethane adhesives are moisture-curing and contain reactive groups and are typically prepared by the reaction of aminosilanes with polyurethane prepolymers containing isocyanate groups. European Patent Application No. EP-A-0 202 491 describes silane-functionalized polyester melt adhesives in which an adduct of a polyester polyol and a diisocyanate is reacted with an amino- or mercaptosilane, or an adduct of an amino- or mercapto-silane and a diisocyanate is reacted with a polyester polyol. EP-A-0 371 370 discloses melt adhesives which after crosslink on exposure to moisture and contain terminal alkoxysilane and/or NCO groups. EP-A-0 371 370 further discloses that these alkoxysilane end groups can be introduced via mercaptosilane or via a series of aminosilanes. European patent application nos. EP-A-0 202 491 and EP-A-0 371 370 are hereby incorporated by reference in their entireties.

In an embodiment, the polyurethane adhesive includes low molecular weight isocyanates. Such low molecular weight isocyanates cross link with cross linking agents, such as polyols or water, and yield a crosslinked polyurethane adhesive.

Adhesion Promoter

In certain embodiments, the biofouling-resistant coatings of the present disclosure include an adhesion promoter in order, for example, to improve the adhesive properties of the biofouling-resistant coatings. In that regard, in an embodiment, the biofouling-resistant coatings described herein include an adhesive layer including an adhesion promotor coupled to the substrate and a tie coat disposed between the adhesive layer and the biofouling-resistant composition.

In an embodiment, the adhesion promoter is a silane coupling agent. In an embodiment, the silane coupling agent is selected from the group consisting of an organoalkoxysilane that includes an acryloxy group, an organoalkoxysilane that includes an amino group, an organoalkoxysilane that includes an epoxy group, an organoalkoxysilane that includes a condensation-reaction product between 3-glycidoxypropyltrialkoxysilane and a silanol-endcapped dimethyloligosiloxane, an organoalkoxysilane that includes a condensation-reaction product between 3-glycidoxypropyltrialkoxysilane and a silanol-endcapped methylvinyloligosiloxane, and an organoalkoxysilane that includes a condensation-reaction product between 3-glycidoxypropyltrialkoxysilane and a silanol-endcapped dimethylsiloxane-methylvinylsiloxane copolymer and mixtures thereof. In an embodiment, the silane coupling agent is selected from the group consisting of 3-methacryloxypropyltrimethoxysilane, 3-acryloxypropyl trimethoxysilane, 3-aminopropyltrimethoxysilane, 3-(2-aminoethyl)-aminopropyl trimethoxysilane, 3-glycidoxypropyltrimethoxysilane, a silanol-endcapped dimethylsiloxane-methylvinylsiloxane copolymer, and mixtures thereof.

In an embodiment, the adhesion promoter is present in the biofouling-resistant coating in an amount of about 0.1 to about 10 parts by weight per 100 parts by weight curably reactive organopolysiloxane. In an embodiment, the adhesion promoter is present in the biofouling-resistant coating in an amount of about 0.1 to about 5 parts by weight per 100 parts by weights curably reactive organopolysiloxane.

In an embodiment, the adhesion promoter includes a mixture of organic and inorganic compounds. In an embodiment, the adhesion promoter includes 60.0-85 wt % octamethyltrisiloxane, 5.0-10.0 wt % 1-methoxyisopropyl orthosilicate, 5.0-10.0 wt % tetrapropyl orthosilicate, and 3.0-7.0 wt % tetrabutyl titanate.

Antibiofoulant

In another embodiment, the biofouling-resistant compositions described herein include an antibiofoulant. Without being bound by theory, it is believed that the antibiofoulant compounds diffuse over time to a surface of the biofouling-resistant coatings described herein and leach out of the biofouling-resistant coatings into water. Such diffusion through the biofouling-resistant coating provides a long-lived resistance to fouling. In an embodiment, the antibiofoulant does not form a bound complex with other components of the biofouling-resistant composition, such as the curably reactive organopolysiloxane.

In an embodiment, the antibiofoulant is selected from the group consisting of algaecides, herbicides, bactericides, pesticides, and combinations thereof. In an embodiment, the antibiofoulant is selected from the group consisting of capsaicin and zosteric acid. In an embodiment, the antibiofoulant is selected from the group consisting of glyphosates, fluoroquinolones, urea-based algaecides, and copper oxides. In an embodiment, the biofouling-resistant compositions described herein include two or more different antibiofoulants.

In an embodiment, the antibiofoulant includes compounds that are stable at processing conditions, do not significantly decrease transmission of light through the biofouling-resistant composition, or damage the biofouling-resistant compositions' physical and mechanical properties. In an embodiment, the antibiofoulant is chosen and incorporated so that it does not excessively decrease transmission of light through the biofouling-resistant composition. Accordingly, in an embodiment, the curably reactive organopolysiloxane and the antibiofoulant form a solid solution, as opposed to a suspension that would, for example, scatter light passing through the biofouling-resistant coating and thereby reduce its optical transparency.

The biofouling-resistant coating can have a variety of thicknesses, such as from about several nanometers up to several millimeters. In an embodiment, biofouling-resistant coating has a thickness from about 50 μm to about 400 μm.

Substrate

The biofouling-resistant coatings described herein are coated onto a substrate. In an embodiment, the substrate is a substrate of a marine instrument for submerged marine applications. The marine instruments suitable for coating by the biofouling-resistant compositions of the present disclosure include any known marine instruments and sensors which are likely to be used underwater for extended periods of time.

As discussed further herein with respect to methods of application, in an embodiment, the substrate is an irregular substrate. Accordingly in an embodiment, the substrate is contoured. In an embodiment, the substrate is multi-faceted. In this regard, the substrate may include irregular and otherwise generally non-planar aspects or portions coated with the biofouling-resistant coatings described herein. Such irregular substrates include, without limitation, marine instruments described further herein such as an acoustic Doppler current profiler.

In an embodiment, the marine instrument includes a waterproof and pressure-proof housing and one or more sensor elements disposed on the housing configured to be exposed to ambient water. In an embodiment, the housing includes a processor, batteries, data storage, and a sensor mount configured to carry the one or more sensor elements. In an embodiment, the sensor element includes a sensor element selected from the group consisting of an acoustic transducer, optical sensor, electromagnetic device, electrode device, strain gage device, and sensing chamber.

In an embodiment, the one or more sensor elements comprise materials selected from the group consisting of stainless steel, glass, epoxy, polyurethane, titanium, and ceramics. The substrate includes any material that suitably adheres to the biofouling-resistant compositions and/or other components of the biofouling-resistant coatings described herein. In an embodiment, the substrate includes material selected from the group consisting of plastics, elastomers, metals and combinations thereof. In an embodiment, the substrate includes a plastic material selected from the group consisting of polyvinylchlorides (PVC), polycarbonates (PC), polyurethanes (PU), polypropylenes (PP), polyethylenes (PE), polyesters, polymethylmethacrylate (PMMA), hydroxyethylmethacrylate, N-vinyl pyrrolidones, fluorinated polymers such as polytetrafluoroethylene, polyamides, polystyrenes, and copolymers or mixtures thereof. In an embodiment, the housing comprises one or more materials selected from the group consisting of aluminum, titanium, stainless steel, copper nickel, glass, polyurethane, poly vinyl chloride, ceramic, poly acetyl, fiberglass-reinforced plastic, carbon fiber-reinforced plastic, and combinations thereof.

In an embodiment, the substrate for submerged marine applications is a marine sensor selected from the group consisting of an electroacoustic marine instrument, a sonic marine instrument, an optical marine instrument, and a marine survey instrument. In an embodiment, the substrate for submerged marine applications is a marine sensor selected from the group consisting of an acoustic Doppler current profiler, an acoustic echosounder, a fanbeam echosounder, a hydrophone listening device, an underwater telephony device, a sonar device, a command and weapons control systems on an underwater vessel, an acoustic homing head, an underwater propelled guided vehicle, an underwater locating apparatus, a submerged navigation and control system for a ship, an underwater recording apparatus, an underwater vibration sensor, an underwater acceleration sensors, a thermometer, a pH meter, a dissolved oxygen sensor, a turbidity measuring device, a fluorimeter, a sediment transport measurement device, and an underwater seismograph.

In an embodiment, the substrate is disposed on a moveable platform. In an embodiment, the substrate is disposed on a substrate of an Autonomous Undersea Vehicle (AUV), a glider, a ship hull, a propeller, or a periscope. In an embodiment, the substrate is disposed on a fixed platform. In an embodiment, the substrate is disposed on a buoy, a bridge, or a piling.

Kits

In another aspect, the present disclosure provides a kit configured to prepare the biofouling-resistant coatings described herein. In an embodiment, the kit comprises a curably reactive organopolysiloxane having at least one terminal-reactive functional group and at least one silicon bonded group; and a cross linking agent. As described further herein, in an embodiment, a reaction product of the curably reactive organopolysiloxane and the organosilane cross linking agent comprises an optically clear, biofouling-resistant composition having greater than 50% light transmission of wavelengths between 400 nm and 800 nm and a refractive index of 1.30 to 1.56, and wherein the coating has a Shore A durometer of greater than 27.

In an embodiment, the curably reactive organopolysiloxane is any curably reactive organopolysiloxane described further herein. In an embodiment, the cross linking agent is any cross linking agent described further herein.

In an embodiment, the kit further comprises a filler. In an embodiment, the filler is any filler further described herein.

In an embodiment, the kit comprises an adhesion promoter. As described further herein with respect to the biofouling-resistant coatings of the present disclosure, the adhesion promotor is configured to aid in adhesion of the tie coat and biofouling-resistant compositions of the present disclosure to the substrates. In an embodiment, the adhesion promoter is any adhesion promoter described herein.

In an embodiment, the kit comprises a diluent. As described further herein with respect to the biofouling-resistant compositions of the present disclosure, in certain embodiments, the diluent is suitable to decrease the viscosity of the curably reactive polyorganosiloxane sufficiently to permit easy application of the biofouling-resistant composition to a substrate. In an embodiment, the diluent is any diluent described further herein.

In an embodiment, the kit comprises a tie coat polymer. As described further herein with respect to the biofouling-resistant coatings of the present disclosure, in certain embodiments, the tie coat configured to form an intimate bond with a substrate. In an embodiment, the tie coat is any tie coat described herein.

In an embodiment, the kit comprises a metal catalyst configured to catalyze a reaction between the curably reactive organopolysiloxane and the organosilane cross linking agent. In an embodiment, the metal catalyst is any metal catalyst described further herein.

As described further herein with respect to the methods of the present disclosure, in an embodiment, certain components of the kits of the present disclosure are reactive with one another. For example, in certain embodiments, the curably reactive organopolysiloxane and organosilane cross linking agent are reactive to cure when they are mixed. Likewise, in certain embodiments, the curably reactive organopolysiloxane and organosilane cross linking agent are reactive when mixed in the presence of, for example, a metal catalyst or water. Accordingly, in an embodiment, the kit comprises two or more fluidically isolated containers each containing one or more components of the kit. In this regard, certain reactive components are fluidically separated until a user is ready to cure the biofouling resistant compositions and form the biofouling resistant compositions.

In an embodiment, one of the two or more fluidically isolated containers does not contain all of the curably reactive organopolysiloxane, the organosilane cross linking agent, and the metal catalyst. In this regard, the metal catalyst does not come premixed with the curably reactive organopolysiloxane, the organosilane cross linking agent. In an embodiment, wherein the curably reactive organopolysiloxane and the organosilane cross linking agent cure in the presence of water, a fluidically isolated container containing the curably reactive organopolysiloxane, the organosilane cross linking agent is also sealed against moisture entering the fluidically isolated container.

In an embodiment, the components of the kit including the curably reactive organopolysiloxane and the organosilane cross linking agent are configured to be sprayed from a sprayer when combined. In this regard, the components of the kit are configured to be applied to a substrate by being sprayed. As discussed further herein, spraying such components onto a substrate provides, inter alia, a smooth, even biofouling-resistant coating onto the substrate. In an embodiment, a thickness of the biofouling-resistant coating has a thickness that varies by less than or equal to ±100 μm when measured over a square centimeter. In an embodiment, the substrate includes irregular substrates as discussed further herein.

Methods of Making a Biofouling-Resistant Coating

In another aspect, the present disclosure provides a method of making a biofouling-resistant coating on a substrate. In an embodiment, the method includes coupling a tie coat to the substrate; applying to the tie coat a mixture comprising a curably reactive and an organosilane cross linking agent; and curing the mixture, wherein the biofouling-resistant coating has a Shore A durometer of greater than 20.

In an embodiment, the curably reactive organopolysiloxane is any curably reactive organopolysiloxane described herein. In an embodiment, the curably reactive organopolysiloxane includes at least one terminal reactive functional group and at least one silicon bonded organic group. In an embodiment, the curably reactive organopolysiloxane is selected from the group consisting of a hydroxyl group, an alkoxy group, an aryloxy group, an amino group, an amido group, a halogen, or a vinyl group. In an embodiment, the at least one silicon bonded organic group selected from the group consisting of a methyl group, an ethyl group, a vinyl group, a haloalkyl group, or a phenyl group.

As discussed further herein with respect to the biofouling-resistant compositions of the present disclosure, in certain embodiments, the biofouling-resistant coatings made in accordance with the methods of the present disclosure have a Shore A durometer of greater than 20, such as between about 20 and about 70.

In an embodiment, the substrate is cleaned before applying the tie coat to the substrate. Accordingly, in an embodiment, prior to applying the tie coat, all bonding surfaces are carefully cleaned, degreased, and dried. In this regard bond strength between the substrate and the biofouling-resistant coating is increased. In an embodiment, chemical etching is employed for optimal adhesion and environmental durability when bonding to certain metal surfaces, vulcanized rubbers, etc. In an embodiment, non-porous surfaces are roughened with sandpaper or emery paper for hard materials. Where appropriate, air plasma or corona treatment is applied to the surface to be coated to improve the characteristics of the materials by raising surface energy (dyne level).

In an embodiment, the method comprises applying an adhesive layer to the substrate, such as a cleaned substrate, wherein the tie coat is coupled to the substrate via the adhesive layer.

In an embodiment, the mixture is formed by uniformly mixing the curably reactive organopolysiloxane and the organosilane cross linking agent and any additional mixture components. The composition can be prepared in a commercial mixer such as a Ross mixer, planetary mixer, or Hobart mixer.

In an embodiment, the mixture comprises a filler. The filler can be any filler described further herein. In an embodiment, the filler is a silica-based filler, as described further herein. Generally, more dispersing energy is needed to disperse a given amount of silica as the surface area increases. In other words, silicas with lower surface area are easier to disperse. In a fully dispersed system, lower surface area silicas require a higher weight loading in the resin than those of higher surface area to achieve similar viscosities and behaviors.

Fumed silicas should be incorporated based on individual formulation needs and experience. Typical application methods suggest that the silica can be incorporated early into the base resin to increase the viscosity of the system. This increase in viscosity results in an increase of the shear forces that are needed for proper dispersion of the silica into the formulation. In many cases, the mixture is sheared until a specific, desired “grind”—as an indication of the extent of dispersion—is achieved. At this point, the other additives, as well as any required reactive diluent, can be added. The actual method of incorporation may vary depending on the specific formulation, dispersing equipment, and customer specificity. Grindometer readings of <50 μm are generally preferred, which indicates nearly complete dispersion. In an embodiment, grindometer readings of 15-40 μm will give suitable anti-settling, anti-sag, clarity, and stability.

In an embodiment, after mixing components of the mixture, the mixture is applied to the substrate. Any application method suitable for applying the mixture to the substrate may be used in accordance with the methods of the present disclosure. In an embodiment, the method of application is selected from the group consisting of dip coating, spray coating or flow coating. For example, they can be deposited via an electrodeposition technique such as electroplating, electrophoretic deposition, or electrobrushing.

In an embodiment, the mixture is applied to the substrate by spray coating the mixture onto the substrate. Spray coating advantageously applies an even and quickly drying coating of the mixture to the substrate. In an embodiment, coatings applied by spraying have thicknesses that when measured over a square centimeter have a thickness that varies between less than or equal to ±100 μm. Spray coating is additionally suitable to quickly coat a number of substrates with a mixture in a relatively short period of time. In this regard, spray coating has a throughput that is higher than certain other methods of depositing coatings onto a substrate.

Further, in an embodiment, mixtures described herein are sprayed onto a substrate without a solvent or other diluent. In this regard, such spray application does not use or otherwise include the vaporization of volatile organic compounds, which have been shown to be harmful to, for example, the environment and human health.

Additionally, spray coating is particularly suitable for coating mixtures onto irregular substrates, such as multi-faceted and/or contoured surfaces. As used herein, an irregular substrate includes one or more surfaces that include one or more of the following features: a non-planar contour and a plurality of facets. As described further herein, many substrates for submerged marine applications, such as acoustic Doppler current profilers, include multi-faceted and/or contoured substrates. Application of mixtures to such complex substrates by certain other methods, such as brush coating, can lead to over application of the mixture and areas of the substrate that include drips and runs. Such uneven coating of mixtures can lead to clogging of complex parts and shapes of the substrate and flaking of the coating from the substrate due to insufficient or incomplete curing. Spray coating, by contrast, applies an even, quick-drying coating of the mixture to the substrate including irregular portions thereof.

In an embodiment, curing includes a reaction selected from the group consisting of addition, condensation, hydrolyzation, dealcoholyzation, deacetification, dehydroxyamination and combinations thereof.

Condensation-cured materials include room-temperature vulcanizing (RTVs) resins, which cure, at least in part, by exposure to ambient moisture. In an embodiment, condensation-cured material also include neutral type configured to be cured by either alkoxy or oxine promoter released from the material. In an embodiment, condensation-cured materials include two part systems. In an embodiment, such two-part condensation-cured materials include a metal catalyst that cure in conjunction with the ambient moisture. These materials are not susceptible to premature curing by exposure to moisture. These material types are typically alkoxy cross link promoter released.

In an embodiment, curing of RTV resins including exposing the deposited RTV resin to ultraviolet (UV) light. Such exposure of RTV resins to UV light accelerates curing of the mixture on the substrate. In an embodiment, curing of an RTV resin by exposure to ambient moisture may take up to a day or more. In an embodiment, curing of an RTV resin by exposing the deposited RTV resin to UV light from a D bulb for about 4 seconds at 5 W/cm² followed by exposure to ambient moisture cures-through in about 5 minutes. Such UV-aided curing is advantageous, for example, when heat curing is not applicable or preferred or when fast curing, such as in high throughput manufacturing, is desirable.

In an embodiment, the mixture further comprises a metal catalyst configured to cure the curably reactive organopolysiloxane and the organosilane cross linking agent. In an embodiment, addition-cured materials use a platinum catalyst. In certain embodiments, addition-cured materials are configured to be heat cured. In certain other embodiments, addition-cured materials are configured to cure at room temperatures. In some embodiments, addition-cured materials do not have by-products.

In certain embodiments, mixing of certain components of the biofouling-resistant compositions described herein causes curing in the presence of adequate moisture and/or heat. Accordingly, in certain embodiments, the components are stored in separate, fluidically isolated containers prior to use. Accordingly, in certain embodiments, the components are stored in containers that exclude moisture. For instance, one container contains a catalyst and a second contains the curably reactive organopolysiloxane and the organosilane cross linking agent. In another embodiment, the catalyst is mixed with the curably reactive organopolysiloxane in one container and the cross linking agent is in a second container. In an embodiment, filler and other ingredients are included in either or both of the parts depending on factors such as stability, viscosity, and interactions.

In an embodiment, the mixture comprises a diluent. The diluent, when included in the mixture, is allowed to evaporate leaving the cured composition. If desired, the coated substrate is heated or radiated to facilitate the cure. Heating can be at temperatures of 50° C. to 120° C. for several minutes up to several hours, depending on the heat stability of the substrate.

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. The term “about” means plus or minus 5% of the stated value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A biofouling-resistant coating on a substrate used for submerged marine applications, the coating comprising:
a tie coat coupled to the substrate; and
a biofouling-resistant composition coupled to the tie coat, the biofouling-resistant composition comprising a reaction product of a mixture comprising:
a curably reactive organopolysiloxane comprising:
at least one terminal reactive functional group; and
at least one silicon-bonded organic group; and
an organosilane cross linking agent;
wherein the biofouling-resistant coating has a Shore A durometer of greater than 20, and
wherein the biofouling-resistant coating has greater than or equal to 25% light transmission of wavelengths between 400 nm and 800 nm.

2. The biofouling-resistant coating of claim 1, wherein the biofouling-resistant coating has a Shore A durometer of between 20 and 70.

3. The biofouling-resistant coating of claim 1, wherein the biofouling-resistant coating has a refractive index of between 1.30 and 1.56.

4. The biofouling-resistant coating of claim 1, wherein the biofouling-resistant coating has a hard fouling resistance of between 0.01 MPa and 0.4 MPa.

5. The biofouling-resistant coating of claim 1, wherein the biofouling-resistant coating has greater than or equal to 50% light transmission of wavelengths between 400 nm and 800 nm.

6. The biofouling-resistant coating of claim 1, wherein the tie coat comprises a polymer selected from the group consisting of an epoxy, a polyurethane, and combinations thereof.

7. The biofouling-resistant coating of claim 1, further comprising an adhesive layer, wherein tie coat is disposed between the adhesive layer and the biofouling-resistant composition.

8. The biofouling-resistant coating of claim 7, wherein the adhesive layer comprises a silane coupling agent.

9. The biofouling-resistant coating of claim 8, wherein the biofouling-resistant coating has a thicknesses that varies between less than or equal to ±100 μm over a square centimeter.

10. The biofouling-resistant coating of claim 8, wherein the substrate is an irregular substrate comprising one or more of a contour and a plurality of facets.

11. The biofouling-resistant coating of claim 1, wherein the substrate comprises a material selected from the group consisting of aluminum, titanium, stainless steel, copper nickel, glass, polyurethane, polyvinyl chloride, ceramic, poly acetyl, fiberglass-reinforced plastic, carbon fiber-reinforced plastic, thermoplastics, thermosets, and combinations thereof.

12. The biofouling-resistant coating of claim 1, wherein the substrate is a substrate of a marine instrument selected from the group consisting of an acoustic sensor, an optical sensor, an electrode, an electromagnetic sensor, and a strain gauge device.

13. The biofouling-resistant coating of claim 1, wherein the substrate includes a serial number or other identification marking that is visible through the biofouling-resistant coating.

14. The biofouling-resistant coating of claim 1, wherein the biofouling-resistant composition further comprises an antifoulant selected from the group consisting of an algaecide, an herbicide, a bactericide, a pesticide, capsaicin, zosteric acid, and combinations thereof.

15. A kit comprising
a curably reactive organopolysiloxane comprising
at least one terminal reactive functional group; and
at least one silicon-bonded organic group; and
an organosilane cross linking agent,
wherein a reaction product of a mixture comprising the curably reactive organopolysiloxane and the organosilane cross linking agent comprises an optically clear, biofouling-resistant composition having greater than or equal to 25% light transmission of wavelengths between 400 nm and 800 nm, a refractive index of 1.30 to 1.56, and a Shore A durometer of greater than 20.

16. The kit of claim 15, further comprising an adhesion promoter.

17. The kit of claim 15, further comprising a filler.

18. The kit of claim 15, further comprising a diluent.

19. The kit of claim 1, further comprising a tie coat polymer.

20. The kit of claim 15, further comprising a metal catalyst configured to catalyze a reaction between the curably reactive organopolysiloxane and the organosilane cross linking agent.

21. The kit of claim 20, further comprising two or more fluidically isolated containers each containing one or more components of the kit, wherein one of the two or more fluidically isolated containers does not contain the curably reactive organopolysiloxane, the organosilane cross linking agent, and the metal catalyst.

22. The kit of claim 15, wherein the curably reactive organopolysiloxane and the organosilane cross linking agent are configured to be sprayed from a sprayer when mixed.

23. A method of forming biofouling-resistant coating on a substrate used for submerged marine applications comprising:
coupling a tie coat to the substrate;
applying to the tie coat a mixture comprising:
a curably reactive organopolysiloxane including:
at least one terminal reactive functional group; and
at least one silicon bonded organic group; and
an organosilane cross linking agent; and
curing the mixture comprising the curably reactive organosiloxane and the organosilane cross linking agent,
wherein the biofouling-resistant coating has a Shore A durometer of greater than 20, and
wherein the biofouling-resistant coating has greater than or equal to 25% light transmission of wavelengths between 400 nm and 800 nm.

24. The method of claim 23, wherein the substrate is cleaned before applying the tie coat to the substrate.

25. The method of claim 23, wherein the mixture further comprises a metal catalyst configured to cure the curably reactive organopolysiloxane and the organosilane cross linking agent.

26. The method of claim 23, wherein applying the mixture to the tie coat comprises an application method selected from the group consisting of dip coating, spray coating, and flow coating.

27. The method of claim 23, wherein applying the mixture to the tie coat comprises spray coating.

28. The method of claim 23, further comprising applying an adhesive layer to the substrate, wherein the tie coat is coupled to the substrate via the adhesive layer.

29. The method of claim 23, wherein the substrate is an irregular substrate comprising one or more of a contour and a plurality of facets.

30. The method of claim 23, wherein the biofouling-resistant coating has a thicknesses that varies between less than or equal to ±100 μm over a square centimeter.
